(19) United States
(12) Patent Application Publication
(10) Pub. No.: US 2020/0214052 A1
(43) Pub. Date: Jul. 2, 2020

(54) PROVIDING GROUP OF DEVICES WITH CELLULAR ACCESS

(71) Applicant: NOKIA TECHNOLOGIES OY, Espoo (FI)

(72) Inventors: Vinh VAN PHAN, Oulu (FI); Zexian LI, Espoo (FI); Ling YU, Kauniainen (FI); Peter ROST, Heidelberg (DE)

(21) Appl. No.: 16/328,377

(22) PCT Filed: Sep. 28, 2016
(86) PCT No.: PCT/FI2016/050677

§ 371 Date: Feb. 26, 2019

(51) Int. Cl. H04W 76/10; H04W 4/70; H04W 8/18

(52) U.S. Cl. CPC H04W 76/10; H04W 84/20; H04W 8/186; H04W 4/70

(57) ABSTRACT

This document discloses a solution for providing a group of devices with a user context. According to an aspect, a method comprises: receiving, at an access node from a network controller, a user context of a networking group, wherein the networking group comprises at least two devices;receiving, at the access node, a connection request from a device belonging to the networking group, wherein the device is in a networking relationship with at least one other user device of the networking group;determining, by the access node on the basis of the received user context, whether or not the connection request shall be handled and responded by the access node; and if the connection request shall be handled by the access node, handling the connection request and generating a response to the device and, otherwise,forwarding the connection request to the network controller.

### FIELD

The invention relates to wireless communication systems and, in particular, to providing a group of devices with cellular access.

### BACKGROUND

The number of networking devices is increasing rapidly, and future cellular communication systems need to have capability of handling vast numbers of connecting devices. Machine-type communications (MTC) and Internet of Things are concepts that are related to many applications where end devices of the cellular connections are sensors or other types of machines communicating with other machines without human interaction. Furthermore, support for various local networking relationships and networking protocols is a desirable feature of future cellular systems.

### BRIEF DESCRIPTION OF THE INVENTION

The invention is defined by the subject-matter of the independent claims. Embodiments are defined in the dependent claims.

According to an aspect, there is provided a method, comprising: receiving, at an access node from a network controller, a user context of a networking group, wherein the networking group comprises at least two devices; receiving, at the access node, a connection request from a device belonging to the networking group, wherein the device is in a networking relationship with at least one other user device of the networking group; determining, by the access node on the basis of the received user context, whether or not the connection request shall be handled and responded by the access node; and if the connection request shall be handled by the access node, handling the connection request and generating a response to the device and, otherwise, forwarding the connection request to the network controller.

In an embodiment, the user context is received upon setup of the networking group initiated by the network controller.

In an embodiment, the user context of the networking group includes at least one of the following user context parameters: an identifier of the networking group, a maximum number of devices of the networking group, security information for the access node to carry out at least one of authentication and authorization and admission control, an identifier of at least one master device of the networking group, an identifier of a neighboring access node involved in serving the networking group and routing information for the networking group, a quality of service classification of the user context, and an indicator of a networking application protocol of the networking group.

In an embodiment, said determining is based on at least one of the following criteria: a quality of service classification for traffic in the networking relationship, whether or not the device belongs to a particular device category within the networking group, whether or not the device requests for a particular service, and whether or not the device has a subscriber identity module of a cellular communication system of the access node.

In an embodiment, the networking group comprises at least one master device and at least one slave device.

In an embodiment, the access node routes to the master device of the networking group a data packet that does not specify a destination.

In an embodiment, the networking group comprises at least one device with a subscriber identity module of a cellular communication system and at least one device with no subscriber identity module of the cellular communication system.

In an embodiment, the access node identifies the at least one device with no subscriber identity module by a combination of an identifier of the at least one device with the subscriber identity module and an identifier of the networking relationship.

In an embodiment, upon determining that the connection request is handled by the access node, performing admission control for the device and informing the network controller of the newly admitted device.

In an embodiment, the networking relationship is defined by a communication protocol other than a communication protocol used for communication between the access node and the networking group.

In an embodiment, said handling the connection request comprises performing at least one of authentication of the device, authorization of the device, and admission control of the device.

In an embodiment, said handling the connection request comprises paging for at least one other device of the networking group.

In an embodiment, the method further comprises at the access node upon receiving the user context: broadcasting a message indicating availability of the user context.

In an embodiment, the method further comprises at the access node: acquiring timing information associated with transmission timings within the networking group; and upon admitting a new device of the networking group to the user context, providing the new device with the timing information.

In an embodiment, the user context comprises an identifier of at least one master device of the networking group, and wherein the access node pages for the master device upon receiving the user context.

In an embodiment, the networking group comprises devices being in the networking relationship over a non-cellular communication protocol, and communication between the access node and the device is carried out over a cellular communication protocol.

According to another aspect, there is provided a method comprising: establishing, by a network controller, a user context for a networking group comprising at least two devices having a networking relationship; transmitting, by the network controller, the user context of the networking group to an access node, wherein the user context comprises at least one parameter indicating tasks of the access node with respect to handling connection requests; receiving, at the network controller from the access node, a connection request associated by a device of the networking group and indicated in the user context as a task handled by the network controller; and handling, at the network controller, the connection request and generating a response to the device.

In an embodiment, the establishment of the user context is initiated by the network controller without a request from the networking group.

According to another aspect, there is provided a method comprising: providing, in a device, a networking relationship with at least one other device, wherein said device and said at least one other device form a networking group; causing, by the device, transmission of a connection request to an access node external to the networking relationship, wherein the connection request comprises a request to join a user context of the networking group at the access node; receiving, by the device, a response indicating admission of the device to the user context shared by the device and the at least one other device of the networking group.

In an embodiment, the method further comprises at the device: detecting availability of the user context at the access node; and causing said transmission of the connection request in response to said detecting.

In an embodiment, said detecting is based on receiving a signal from the access node, the signal comprising information indicating the availability of the user context at the access node.

In an embodiment, the user context is of a cellular communication system, and wherein the device has no subscriber identity module of the cellular communication system.

In an embodiment, the method further comprises: receiving, in connection with the response indicating admission of the device to the user context, timing information on the networking relationship; and using the timing information when transmitting a message within the networking relationship or over a bearer service of the user context.

In an embodiment, the networking relationship is defined by a communication protocol other than a communication protocol used for communication of the device with the access node.

In an embodiment, the networking group comprises devices being in the networking relationship over a non-cellular communication protocol, and communication between the device and the access node is carried out over a cellular communication protocol.

According to another aspect, there is provided an apparatus comprising: at least one processor, and at least one memory comprising a computer program code, wherein the processor, the memory, and the computer program code are configured to cause the apparatus to: receive, from a network controller, a user context of a networking group, wherein the networking group comprises at least two devices; receive a connection request from a device belonging to the networking group, wherein the device is in a networking relationship with at least one other user device of the networking group; determine, on the basis of the received user context, whether or not the connection request shall be handled and responded by the apparatus; and if the connection request shall be handled by the apparatus, handle the connection request and generate a response to the device and, otherwise, forward the connection request to the network controller.

In an embodiment, the processor, the memory, and the computer program code are configured to cause the apparatus to receive the user context during setup of the networking group initiated by the network controller.

In an embodiment, the user context of the networking group includes at least one of the following user context parameters: an identifier of the networking group, a maximum number of devices of the networking group, security information for the apparatus to carry out at least one of authentication and authorization and admission control, an identifier of at least one master device of the networking group, an identifier of a neighboring access node involved in serving the networking group and routing information for the networking group, a quality of service classification of the user context, and an indicator of a networking application protocol of the networking group.

In an embodiment, the processor, the memory, and the computer program code are configured to cause the apparatus to perform said determining as based on at least one of the following criteria: a quality of service classification for traffic in the networking relationship, whether or not the device belongs to a particular device category within the networking group, whether or not the device requests for a particular service, and whether or not the device has a subscriber identity module of a cellular communication system of the apparatus.

In an embodiment, the networking group comprises at least one master device and at least one slave device.

In an embodiment, the processor, the memory, and the computer program code are configured to cause the apparatus to route to the master device of the networking group a data packet that does not specify a destination.

In an embodiment, the networking group comprises at least one device with a subscriber identity module of a cellular communication system and at least one device with no subscriber identity module of a cellular communication system.

In an embodiment, the processor, the memory, and the computer program code are configured to cause the apparatus to identify the at least one device with no subscriber identity module by a combination of an identifier of the at least one device with the subscriber identity module and an identifier of the networking relationship.

In an embodiment, the processor, the memory, and the computer program code are configured to cause the apparatus to perform, upon determining that the connection request shall be handled by the apparatus, admission control for the device and inform the network controller of the newly admitted device.

In an embodiment, the networking relationship is defined by a communication protocol other than a communication protocol used for communication between the access node and the networking group.

In an embodiment, the processor, the memory, and the computer program code are configured to cause the apparatus to handle the connection request by at least performing at least one of authentication of the device, authorization of the device, and admission control of the device.

In an embodiment, the processor, the memory, and the computer program code are configured to cause the apparatus to perform said handling the connection request by at least paging for at least one other device of the networking group.

In an embodiment, the processor, the memory, and the computer program code are configured to cause the apparatus to broadcast, upon receiving the user context, a message indicating availability of the user context.

In an embodiment, the processor, the memory, and the computer program code are configured to cause the apparatus to acquire timing information associated with transmission timings within the networking group and, upon admitting a new device of the networking group to the user context, provide the new device with the timing information.

In an embodiment, the user context comprises an identifier of at least one master device of the networking group, and wherein the processor, the memory, and the computer program code are configured to cause the apparatus to page for the master device upon receiving the user context.

In an embodiment, the networking group comprises devices being in the networking relationship over a non-cellular communication protocol, and communication between the access node and the device is carried out over a cellular communication protocol.

According to another aspect, there is provided an apparatus comprising: at least one processor, and at least one memory comprising a computer program code, wherein the processor, the memory, and the computer program code are configured to cause the apparatus to: establish a user context for a networking group comprising at least two devices having a networking relationship; transmit the user context of the networking group to an access node, wherein the user context comprises at least one parameter indicating tasks of the access node with respect to handling connection requests; receive, from the access node, a connection request associated by a device of the networking group and indicated in the user context as a task handled by the apparatus; and handle the connection request and generate a response to the device.

In an embodiment, the processor, the memory, and the computer program code are configured to cause the apparatus to initiate the establishment of the user context without a request from the networking group.

According to another aspect, there is provided an apparatus comprising: at least one processor, and at least one memory comprising a computer program code, wherein the processor, the memory, and the computer program code are configured to cause the apparatus to: provide a networking relationship with at least one other apparatus, wherein said apparatus and said at least one other apparatus form a networking group; cause transmission of a connection request to an access node external to the networking relationship, wherein the connection request comprises a request to join a user context of the networking group at the access node; receive a response indicating admission of the apparatus to the user context shared by the apparatus and the at least one other apparatus of the networking group.

In an embodiment, the processor, the memory, and the computer program code are configured to cause the apparatus to: detect availability of the user context at the access node; and cause said transmission of the connection request in response to said detecting.

In an embodiment, the processor, the memory, and the computer program code are configured to cause the apparatus to detect the availability of the user context based on reception of a signal from the access node, the signal comprising information indicating the availability of the user context at the access node.

In an embodiment, the user context is of a cellular communication system, and wherein the device has no subscriber identity module of the cellular communication system.

In an embodiment, the processor, the memory, and the computer program code are configured to cause the apparatus to: receive, in connection with the response indicating admission of the apparatus to the user context, timing information on the networking relationship; and use the timing information when transmitting a message within the networking relationship or over a bearer service of the user context.

In an embodiment, the networking relationship is defined by a communication protocol other than a communication protocol used for communication of the device with the access node.

In an embodiment, the networking group comprises devices being in the networking relationship over a non-cellular communication protocol, and communication between the apparatus and the access node is carried out over a cellular communication protocol.

In an embodiment, the apparatus further comprises radio interface components providing the apparatus with radio communication capability.

According to another aspect, there is provided a computer program product embodied on a distribution medium readable by a computer and comprising program instructions which, when loaded into an apparatus, execute any one of the above-described methods.

### LIST OF DRAWINGS

In the following, the invention will be described in greater detail with reference to the embodiments and the accompanying drawings, in which

FIG. 1 illustrates some wireless communication scenarios to which embodiments of the invention may be applied;

FIGS. 2 to 4 illustrate flow diagrams of processes for providing a networking group of devices with cellular access according to some embodiments of the invention;

FIG. 5 illustrates a signaling diagram for configuring a user context to be shared by a networking group of devices according to an embodiment of the invention;

FIG. 6 illustrates an embodiment for identifying devices within a shared user context;

FIG. 7 illustrates an embodiment for using information on neighboring access nodes allocated to the user context in routing packets;

FIG. 8 illustrates an embodiment for reaching a master device that is remote with respect to slave devices of a networking group;

FIGS. 9 and 10 illustrate embodiments for using information on a networking relationship of a networking group sharing the same user context in configuration of the user context;

FIG. 11 illustrates an embodiment where admission of a device to the user context triggers attaching of at least one other device to the user context; and

FIGS. 12 to 14 illustrate block diagrams of apparatuses according to some embodiments of the invention.

### DESCRIPTION OF EMBODIMENTS

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

Embodiments described may be implemented in a radio system, such as in at least one of the following: Universal Mobile Telecommunication System (UMTS, 3G) based on basic wideband-code division multiple access (W-CDMA), high-speed packet access (HSPA), Long Term Evolution (LTE), LTE-Advanced, a system based on IEEE 802.11 specifications, a system based on IEEE 802.15 specifications, and/or a fifth generation (5G) mobile or cellular communication system.

The embodiments are not, however, restricted to the system given as an example but a person skilled in the art may apply the solution to other communication systems provided with necessary properties. One example of a suitable communications system is the 5G system, as listed above. 5G has been envisaged to use multiple-input-multiple-output (MIMO) multi-antenna transmission techniques, more base stations or nodes than the current network deployments of LTE, by using a so-called small cell concept including macro sites operating in co-operation with smaller local area access nodes and perhaps also employing a variety of radio technologies for better coverage and enhanced data rates. 5G will likely be comprised of more than one radio access technology (RAT), each optimized for certain use cases and/or spectrum. 5G system may also incorporate both cellular (3GPP) and non-cellular (e.g. IEEE) technologies. 5G mobile communications will have a wider range of use cases and related applications including video streaming, augmented reality, different ways of data sharing and various forms of machine type applications, including vehicular safety, different sensors and real-time control. 5G is expected to have multiple radio interfaces, including apart from earlier deployed frequencies below 6 GHz, also higher, that is cmWave and mmWave frequencies, and also being capable of integrating with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as inter-RI operability between cmWave and mmWave). One of the concepts considered to be used in 5G networks is network slicing in which multiple independent and dedicated virtual sub-networks (network instances) may be created within the same infrastructure to run services that have different requirements on latency, reliability, throughput and mobility.

FIG. 1 illustrates an example of a communication system to which some embodiments of the invention may be applied. The system may comprise one or more access nodes 110, 112 providing and managing respective cells 100, 102. The cell may be, e.g., a macro cell, a micro cell, femto, or a pico cell, for example. From another point of view, the cell may define a coverage area or a service area of the access node. The access node 110, 112 may be an evolved Node B (eNB) as in the LTE and LTE-A, an access point of an IEEE 802.11-based network (Wi-Fi or wireless local area network, WLAN), or any other apparatus capable of controlling radio communication and managing radio resources within a cell. For 5G solutions, the implementation may be similar to LTE-A, as described above. The access node may equally be called a base station. The system may be a wireless communication system composed of a radio access network of access nodes, each controlling a respective cell or cells. The access nodes may provide terminal devices (UEs) with wireless access to other networks such as the Internet. In some scenarios, one or more local area access nodes may be arranged within a control area of a macro cell access node. The local area access node may provide wireless access within a sub-cell that may be comprised within a macro cell. Examples of the sub-cell may include a micro, pico and/or femto cell. Typically, the sub-cell provides a hot spot within the macro cell. The operation of the local area access node may be controlled by an access node under whose control area the sub-cell is provided. In some scenarios, a plurality of local area access nodes may be controlled by a single macro cell access node.

In the case of multiple access nodes in the communication network, the access nodes may be connected to each other with an interface 150. LTE specifications call such an interface as X2 interface. In IEEE 802.11 networks, a similar interface is provided between access points. Other wired or wireless communication methods between the access nodes may also be possible. The access nodes may be further connected via another interface 152, 154 to a network controller 136. The network controller 136 may control the operation of the access nodes. In an embodiment, the network controller is comprised in a core network of the cellular communication system. The LTE specifications specify the core network as an evolved packet core (EPC), and the core network may comprise a mobility management entity (MME) and a gateway (GW) node. The MME may handle mobility of terminal devices in a tracking area encompassing a plurality of cells and also handle signalling connections between the terminal devices and the core network. The gateway node may handle data routing in the core network and to/from the terminal devices. In some scenarios, the different access nodes may be connected to different core networks. The different core networks may be operated by the same operator or by different operators.

In an embodiment, the network controller 136 is the MME or a module in the MME.

The radio system of FIG. 1 may support Machine Type Communication (MTC). MTC may enable providing service for a large amount of MTC capable devices.

The MTC device may comprise a mobile phone, smart phone, tablet computer, laptop or other devices used for user communication with the radio communication network, such as an MTC network. These devices may provide further functionality compared to the MTC scheme, such as communication link for voice, video and/or data transfer. However, in MTC perspective the device may be understood as a MTC device. It needs to be understood that the device may also comprise another MTC capable device, such as a sensor device providing position, acceleration and/or temperature information to name a few examples. Some embodiments of the invention may thus be applicable to Internet of Things (IoT) systems, e.g. a radio access technology supporting a narrowband loT (NB-IoT) communication scheme.

FIG. 1 illustrates a scenario where multiple devices such as the MTC devices have a networking relationship according to one or more networking protocols. The networking relationship may be logically distinct from cellular networking. An example of the one or more networking protocols of the networking relationship amongst the devices is WirelessHART which is a wireless sensor networking technology based on Highway Addressable Remote Transducer Protocol (HART). Another standardized embodiment of the one or more networking protocols is Time-Sensitive Networking (TSN) which is a set of standards under development by the Time-Sensitive Networking task group of an IEEE 802.1 working group. Embodiments of the invention described below provide such a networking group of devices with cellular access via the one or more access nodes 110, 112.

In the scenario of FIG. 1, there are two networking groups of devices: a first group served by the access node 110 and a second group served by the access node 112. In other embodiments, multiple access nodes 110, 112 may be configured to collaboratively serve a single group. The devices are denoted by M for a master device and S for a slave device. HART and TSN employ such a master-slave hierarchy.

In this embodiment, all the devices of the networking relationship of the second group are comprised in the cell 102. However, the first group has a remote master that is located outside the cell 100.

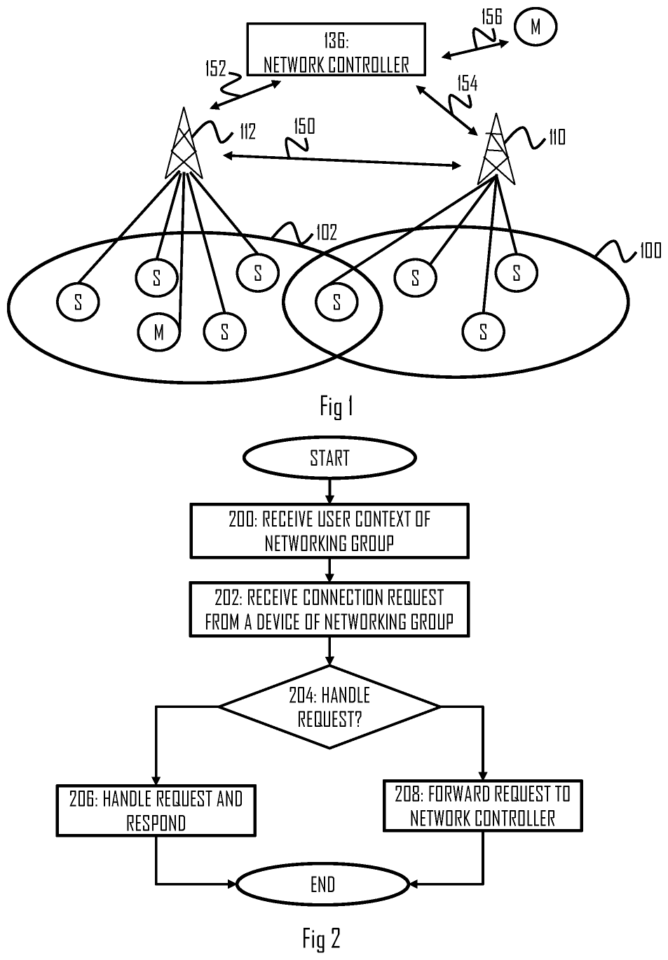

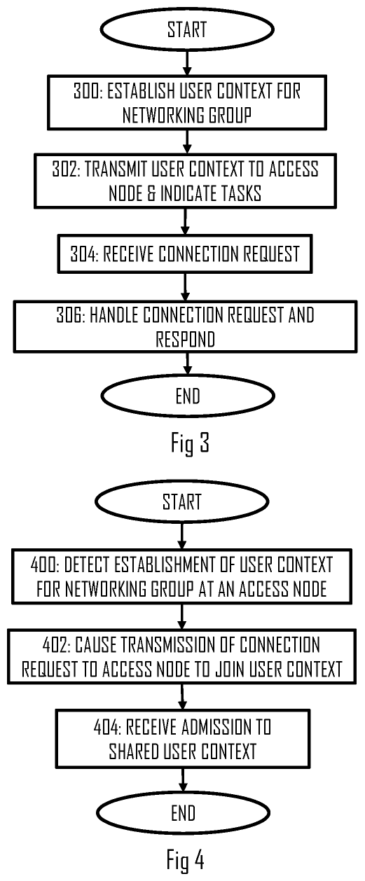

As described above, the total number of devices served with cellular connectivity may be high and, therefore, it may be desirable to optimize the cellular connectivity of the devices. FIGS. 2 to 4 below illustrate a solution for providing such a group of users having a networking relationship with cellular access. FIG. 2 illustrates a process executed in an access node 110, 112, FIG. 3 illustrates a process executed in a network controller 136, and FIG. 4 illustrates a process executed in a device provided with a cellular access.

Referring to FIG. 2, the process comprises in an access node: receiving (block 200), from a network controller, a user context of a networking group, wherein the networking group comprises at least two devices; receiving (block 202) a connection request from a device belonging to the networking group, wherein the device is in a networking relationship with at least one other user device of the networking group; determining (block 204), on the basis of the received user context, whether or not the connection request shall be handled and responded by the access node; and if the connection request shall be handled by the access node, handling (block 206) the connection request and generating a response to the device and, otherwise, forwarding (block 208) the connection request to the network controller.

Referring to FIG. 3, the process comprises in the network controller: establishing (block 300) a user context for a networking group comprising at least two devices having a networking relationship; transmitting (block 302) the user context of the networking group to an access node, wherein the user context comprises at least one parameter indicating tasks of the access node with respect to handling connection requests; receiving (block 304), from the access node, a connection request associated by a device of the networking group and indicated in the user context as a task handled by the network controller; and handling (block 306) the connection request and generating a response to the device.

In an embodiment, the establishment of the user context is initiated by the network controller without a request from the networking group. This distinguishes the invention from regular establishment of the user context that are typically initiated by a terminal device or user equipment by transmitting an attach request or a connection request to the cellular network. In industrial applications and many other applications, the user context may be generated before there is any devices to be connected to the network. Let us consider a factory, a harbor, or a transportation terminal where a sensor network is being built. An operator or a network administrator may first configure the network controller 136 with parameters defining the user context for connecting the devices to the cellular network. When the user context has been established at the network controller 136 and the access node(s) 110, 112, devices may be made aware of the cellular connectivity service and added to employ the user context.

Referring to FIG. 4, the process comprises in the device having a networking relationship with at least one other device, wherein said device and said at least one other device form a networking group: detecting establishment of a user context for the networking group at an access node (block 400); causing (block 402) transmission of a connection request to the access node, wherein the connection request comprises a request to join the user context of the networking group; and receiving (block 404) a response indicating admission of the device to the user context shared by the device and the at least one other device of the networking group.

Let us now describe the procedure of setting up the cellular access for the networking group. With respect to the definition of the networking group, the networking group may refer to a group of devices that have the networking relationship that is distinct from the cellular access or cellular connectivity. As described above, the networking group may form a wireless network according to a network layer protocol and/or an application layer protocol that is/are distinct from any cellular protocols. The networking group may form the networking relationship by establishing a wireless or mobile ad hoc network. Such a networking group of devices that form a wireless network may then be considered as a group entity for the cellular access, as described in this document. In other words, a local (MTC) network may be considered as a single user entity in the cellular network providing the cellular access. This improves the efficiency in terms that a shared user context may be used for multiple MTC devices.

Referring to FIG. 5, the network controller 136 may initiate the establishment of the user context for the networking group of devices, including a master device and at least one slave device. The master device could be equally called a host device and the slave device called a field device, depending on the specifications of the networking relationship 550 of the networking group. The initiation may be triggered by an operator or an administrator entering specifications of the networking group to the network controller 136. The specifications may include an identifier of the networking group, e.g. an identity of the networking relationship such as a network identifier. The specifications may further include information on the networking relationship, e.g. one or more protocols of the networking relationship such as the HART or TSN. Upon receiving the specifications, the network controller 136 may generate the user context by selecting a cellular network identifier for the user context and parameters of the user context. The parameters may include one or more security keys, information on distribution of tasks between an access node and the network controller in handling connection requests, quality of service (QoS) classification for the user context, information on access nodes involved in the establishment of the user context, a maximum number of devices allowed to join the user context, etc.

Upon generating the parameters of the user context, the network controller may activate the user context by transmitting the user context to the access node in step 500. Upon receiving the user context in step 500, the access node may store the parameters of the user context and start establishment of a bearer service between the network controller and the access node for the user context (block 504). Block 504 may comprise at least some operations conventionally used when establishing an evolved packet system (EPS) service, such as establishment of a logical data connection between the network controller (or another data router such as a data gateway node) and the access node for the user context. Upon activation of the user context and establishing the required bearer service(s), the access node may in step 506 announce the presence of the user context. Step 506 may comprise broadcasting a radio signal indicating the availability of the user context. The radio signal may further comprise an identifier of the user context such as a cellular identifier of the user context of the networking group or an identifier of the networking relationship of the networking group, as received in step 500, such that the devices of the networking group become aware of the cellular access established for them. The broadcasted identifier may be the identifier generated by the network controller for the user context. When the broadcasted identifier is the cellular identifier, the devices of the networking group may have been preconfigured with the cellular identifier such that they are able to recognize from the cellular identifier that the user context has been configured for them. When, the broadcasted identifier is the identifier of the networking relationship, the identifier inherently associates the user context with the networking relationship such that the devices are capable of recognizing that user context has been configured for them.

In an embodiment, the network controller provides the access node with an identifier of the master device in step 500. Upon completing the activation of the user context, the access node may start paging for the master device (step 508) in order to request the master device to join the user context. Upon receiving the paging request in step 508, the master device may generate a connection request to join the user context (step 510). Upon receiving the connection request from the master device, the access node may refer to the parameters of the user context received in step 500 and determine whether or not the network controller has tasked the access node to handle the connection request from the master device. In this embodiment, let us assume the situation where the network controller has configured the access node to handle the connection requests of only the slave devices. Accordingly, the network controller may have provided the access node with security information for authentication, authorization, and/or admission control of only the slave devices. As a consequence, upon determining that the access node shall handle the connection requests of only the slave devices (block 512), the access node may forward the connection request to the network controller in step 514.

Upon receiving the connection request, the network controller may perform admission control, authentication, and/or authorization to either accept or reject the connection request from the master device. The authentication and/or authorization may involve state-of-the-art procedures for verifying an identity of the master device. The admission control may include state-of-the-art procedures for determining whether or not to admit the master device to use the user context for cellular access. Upon determining to admit the master device to join the user context, the network controller may transmit a context update message to the access node (step 516), thus indicating the admission of the master device to the user context. The reception of the context update message in step 516, the access node may start establishment of a radio bearer service to establish a radio connection between the access node and the master device (step 518). Step 518 may include procedures for establishing a control plane and, optionally, a data plane radio connectivity for the master device.

Upon detecting the presence of the user context, the slave device may trigger joining to the user context. The detection may be based on receiving the indication from the access node in step 506 or reception of a command to join the user context from an operator and/or through the networking relationship, for example. The triggering may result in transmission of a connection request to the access node in step 520. The connection request may comprise an identifier of the slave device or another indication that the connection request is from a slave device. Upon receiving the connection request in step 520 and detecting that the request is from the slave device, the access node may determine, on the basis of the task distribution indicated in step 500, that the connection request shall be handled by the access node (block 522). Accordingly, the access node may perform the admission control, authentication, and/or authorization for the slave device. Upon determining to admit the slave device to join the user context, the access node establishes and configures a radio bearer for the slave device (step 524). Step 524 may comprise similar operations as in step 518. When the slave device has been joined to the user context, the access node may transmit a context update message to the network controller to inform the network controller of the new member in the user context.

In an embodiment, the connection request in step 510 and 520 comprises an identifier of the user context of the networking group or an identifier of the networking relationship stored in the access node as a part of the user context.

In an embodiment, the connection request in step 510 and 520 comprises an indicator of whether the requesting device is a master device or a slave device. The access node may use this information to determine whether or not it is tasked to handle the request or to forward the request to the network controller, as described above.

In an embodiment, the connection request in step 510 and 520 comprises an indicator of whether or not the device is requesting a connection to the network controller (the bearer service of block 504). This indicator may indicate whether or not the requesting device needs a core network connection. The user credentials may include preconfigured per-device, per-sub-group or per-device-category, or a group-wise identity and corresponding security information such as a security key. For security reasons, the user credentials may be encrypted.

In an embodiment, the connection request in step 510 and 520 comprises credential information of the networking group, e.g. an identifier of the networking relationship.

In an embodiment, the network controller 136 may receive a request from a device for a user context activation of an identified networking group. The user context may have already been established and stored for the activation in the access node(s) and the network controller, or the request may precede step 500 and trigger step 500. The requesting device may be the master device of the networking group. The request may be triggered in the master device by an indication from the serving access node of the requesting device that the serving network is supporting the device-initiated activation of the user context and providing radio access services for networking groups.

In the embodiment of FIG. 5, the task distribution is based on the master/slave role of the devices of the networking group. In other embodiments, the task distribution is based on another factor. In an embodiment, the task distribution is based on whether or not the requesting device has a subscriber identity module (SIM) of the cellular system. The SIM refers to an integrated circuit chip that is intended to securely store an international mobile subscriber identity (IMSI) number and its related key of the device. Alternatively, the SIM can be a software SIM or a virtual SIM as well. Software SIM refers to a SIM that is realized without a physical SIM card, and virtual SIM refers to that the SIM identity of device is hosted in another device, e.g. in a router or a server. This information on the SIM is used to identify and authenticate subscribers in cellular connectivity devices and services. For example, the network controller may handle the connection requests of the devices having the SIM while the access node may handle the connection requests from the SIMless devices. The admission control and, in particular, authentication, may be different for SIM devices and SIMless devices. For example, the network controller may carry out full authentication of the SIM devices while the access node may carry out reduced authentication for the SIMless devices. Such a simplified authentication for the SIMless devices allows the SIMless devices to connect to the cellular network while reducing the signaling.

In the embodiment of FIG. 5, the task distribution defines which one of the access node and the network controller manages QoS conversions between the networking relationship and the user context of the cellular access. The networking relationship may employ a certain QoS classification for data transferred within the networking relationship, and the QoS classification may differ from QoS classification in the user context. The access node and/or the network controller may store a mapping table between the two QoS classification systems to enable the conversion.

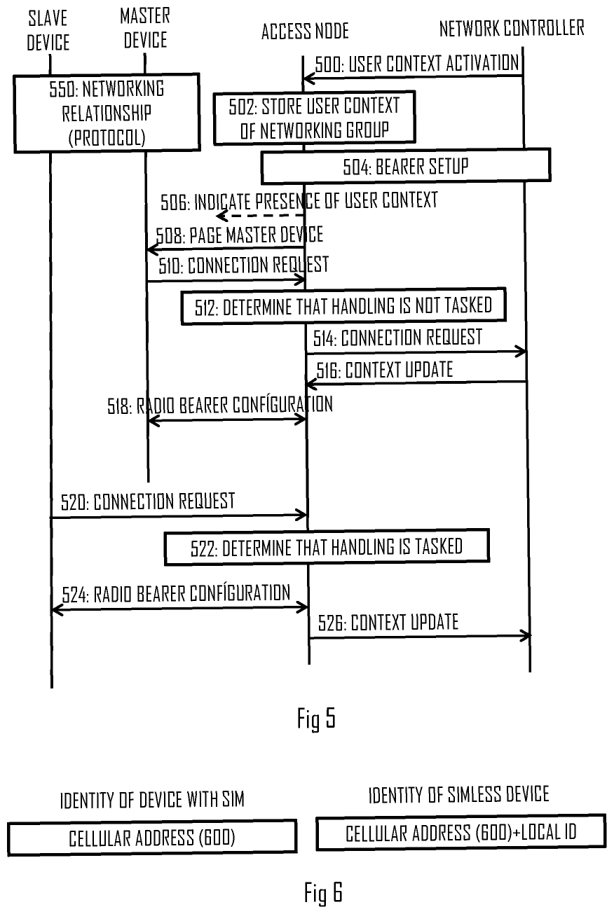

FIG. 6 illustrates an embodiment for identifying the SIM devices and SIMless devices in the user context. The SIM devices that have been authenticated may be identified by using a cellular address 600. However, the SIMless devices may be mapped to the SIM devices by assigning the SIMless device an identity that is a combination of an authenticated identity of the associated SIM device and an identity assigned to the SIMless device specifically for the networking relationship. An example is that the SIMless device is assigned with an identifier that is a combination of the cellular address 600 of the mapped SIM device and a device address of the SIMless device in the networking relationship, e.g. a local identifier in the networking relationship such as a HART address, a TSN address, or a shortened version of an IMSI of the authenticated SIM device.

In another embodiment, even a device with a SIM may be identified in the networking group by an address of the networking relationship, e.g. the HART or TSN address.

In an embodiment, the networking group may be identified with at least one of the following: a group identifier, a user group type or priority, and individual identifiers of the devices such as identifiers assigned to the devices specifically for the networking relationship.

With respect to the distribution of the tasks between the access node and the network controller, the distribution may be carried out in an unconventional manner with respect to how the task distribution is carried out in a conventional cellular network. Considering that the network controller is a MME or a similar controller of a core network, a conventional solution is that the access node and the network controller carry out logically different procedures. For example, the access node carries out access stratum (AS) procedures and the network controller carries out non-access stratum (NAS) procedures, according to the terminology of the LTE. The AS and NAS are logically different protocol layers. However, in the present invention the task distribution may be carried out for tasks of the same protocol layer. For example, the authentication may be assigned to either the access node or the network controller, depending on the configuration. A criterion for the distribution may be the master/slave role of the requesting device, possession of the SIM in the requesting device, a device category within the networking relationship, a requested service type specified in the connection request, or another factor. For example, if the connection request specifies the need for only a radio bearer service, the connection request may be handled by the access node. If the connection request specifies the need for the core network connection, the access node may forward the request to the network controller.

Regarding block 500, the parameters of the user context transferred to the access node may include identity and security context information of the networking group and, additionally, in formation on networking topology of the networking relationship, an indication of a networking protocol and/or application layer protocol of the networking relationship, such as HART or TSN, traffic demand of the networking group, identifiers of individual members of the networking group, etc. Accordingly, the parameters may indicate necessary identities different from regular cellular identities and, additionally or alternatively, characteristics of the networking group in the networking relationship.

With respect to the context update in step 526, the access node may be configured to update the network controller with the newly admitted device immediately on-the-fly, or the access node may wait and aggregate multiple admissions of different devices before the context update of step 526. For example, if the newly admitted user device is of a certain type of device, e.g. having preconfigured per-individual credentials causing the full authentication, the access node may carry out step 526 immediately. For those devices with no preconfigured per-individual credentials, the context update may be periodical, threshold-based, or event triggered, e.g. dependent on the number of such user devices in the networking group. Note that the access node may not need to update the newly admitted user device to the network controller every time, if the aim is to give the access node a certain level of the control on the networking group and reduce the signaling and processing overhead towards the core network and the network controller. The update may be carried out only when the access node detects the need to update the bearer service established in block 504 due to the newly admitted device. However, in some embodiments, the network controller may prefer to keep up-to-date information of the network status and topology of the networking group and, accordingly, immediate context updates may be necessary.

In an embodiment, the network controller may deactivate the user context upon detecting a determined event, e.g. a master device or all master devices disconnect. The deactivation may comprise indicating the deactivation of the user context to the access node and dismantling the bearer service(s) of the user context. The access node may, however, store parameters of the user context for fast reactivation.

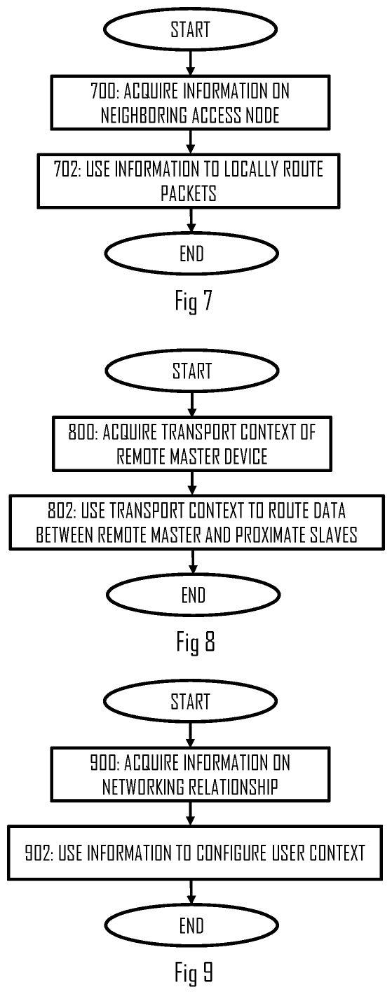

In an embodiment, the user context of the networking group may further include an identity and bearer or transport tunnel configuration of a neighboring access node involved in serving the networking group. Referring to FIG. 1, if the access nodes 110, 112 both serve the same networking group, each access node may be provided with the user context, and the user context may indicate the access nodes involved in serving the networking group. FIG. 7 illustrates a process for using this information in the access node. Referring to FIG. 7, the access node receiving the parameters of the user context may acquire (block 700), from amongst the parameters, information on a neighboring access node also configured to provide the user context. The different access node may establish different bearer services towards the network controller and towards the devices of the networking group. The access node may, on the basis of the information acquired in block 700 establish a direct connection to the other access node or nodes and use the direct connection to route data packets between the devices of the networking group. The direct connection may be established over an X2 interface or a similar interface, depending on the cellular system. This enables efficient routing of data packets, as they need not be routed through the core network.

In an embodiment, the user context may specify routing information that indicates a route to the master device of the networking group. This may be useful in the situation where the master device is remote with respect to the slave devices, e.g. not in the same cell and/or in neighboring cells, as illustrated in FIG. 1. The user context may, for example, specify an identifier of a bearer service of the master device. In general, the user context may comprise a transport context of the master device to facilitate routing of data packets to the master device. FIG. 8 illustrates such an embodiment executed in the access node. Referring to FIG. 8, the access node acquires the transport context of the remote master device in block 800. The transport context may be provided as a part of the context update in step 516 as follows. The establishment of the bearer service for the networking group in block 506 may also trigger establishment of a similar bearer service for the networking group between the network controller and one or more other access nodes, e.g. all the access nodes configured by the network controller to be involved in serving the networking group. Accordingly, each access node may be provided with the transport context information of the master device in the context update such that all the access nodes become aware as how to reach the master device. Accordingly, the access node may use the transport context to route the data from slave devices proximate to the access node to the remote master device (block 802).

In an embodiment, the bearer service established in block 506 may be used to route the data of all devices of the networking group, not only data of the master device for which the bearer service was initially established.

With respect to the routing of data packets, a format of data packets such as a medium access control (MAC) or a packet data convergence protocol (PDCP) protocol data unit (PDU) format may be adapted for direct point-to-point, point-to-multipoint or to-infrastructure transmission so that the serving access node may map and route the packet optimally. For example, preconfigured source or destination addresses or identifiers of the transmitting device and/or receiving device (or device group) may be included in a header of a PDU received and forwarded by the access node. The access node may be configured to add, remove or swap the source or destination address, depending on the routing configuration. In an embodiment, the access node swaps an identifier of a receiving device in the received packet with an identifier of the transmitting device when forwarding the packet to the receiving end directly. Let us elaborate this embodiment in greater detail. Conventionally, both source address and destination addresses are included in a packet header for routing reasons. In this embodiment, as the serving access node schedules transmissions to both source and recipient device, the serving access node should already know from which source device the packet is received and to which recipient device the received packet shall be forwarded. Thus, when the source device transmits the packet to the serving access node, may exclude the source address of its own from the packet and include only an address of the recipient device in the packet. Then when the access node forwards the packet to the recipient device, the access node may modify the only address field of the packet by swapping the address of the recipient device by an address of the source device so that the recipient device knows the source of the packet. This may reduce the signaling overhead because one address field may be omitted. In other option, the access node may remove the address of the recipient device from the forwarded packet without the swapping. The source and destination address information may be included in upper layer signaling (service data unit) of e.g. HART/TSN protocols. This applies to the case where the transmitting device and the receiving device are both located in the cell managed by the access node. The access node may maintain the source and destination addresses intact in the packet header, if the packet is forwarded to another access node via the X2 interface or a similar interface.

Since the networking group may share one or more bearer services towards the core network, as described above, virtual tunnel end-point identifiers (TEI) may be used to distinguish the data packets of each device. The TEI may be realized by using corresponding device identifiers (see FIG. 6 for example) or radio bearer identifiers of individual devices of the networking group in the headers of the data packets transmitted through the shared core network connection(s).

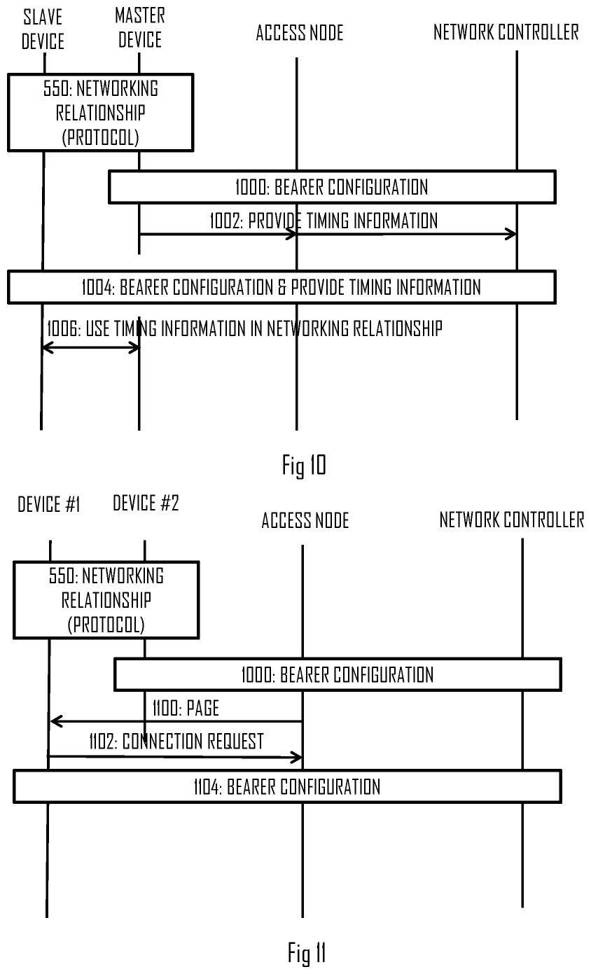

As already described above, the network controller and the access node may employ information on the networking relationship in the user context. The information may enable better adaptation of the cellular access service to the characteristics of the networking relationship. FIGS. 9 and 10 illustrate some embodiments related to this aspect. Referring to FIG. 9, let us consider a process that may be executed in the access node and/or in the network controller. In block 900, information on the networking relationship is acquired. The information may include a type of the networking relationship such as one or more networking protocols, location information or spatial distribution of the devices in the cells of the involved access nodes, timing or synchronization information of the networking relationship, and/or roles and/or expected traffic demands of individual devices or their subsets. This information enables the access node and the network controller to adapt the parameters of the user context to the characteristics of the networking group, and the information may be updated according to the mobility of the devices or changing characteristics in general. For example, availability of such information enables the network controller to configure new access nodes and bearer services for the networking group and/or remove unnecessary access nodes and dismantle unnecessary bearer services from serving the networking group. It may also enable making optimal routing decision such as the local routing between the access nodes, as described above. It also enables estimation of changing traffic demand of the networking group and adaptation of the capacity of the bearer services to the changing demand.

Other embodiments may employ the information on the networking relationship in another manner. As application and context aware networking is featuring many current and future cellular networks, radio access network protocols such as PDCP or MAC protocols may be adapted and parameterized specifically for the networking relationship, e.g. HART or TSN. The access node may adapt its PDCP or MAC protocols or their use to correspond to the corresponding lower layer protocols in the networking relationship. For example, if a networking relationship specifies strict requirements for data transmission characteristics such as the timing and/or packet size of the transmissions, the access node may employ similar transmission characteristics in the radio bearer service of the networking group having such a networking relationship. As another example, radio resource control (RRC) may have some control functions that are specific for the networking relationship such as indicating or broadcasting support for the networking relationship. An access node may, for example, broadcast an indication that it serves only devices associated with a certain networking relationship such as the HART or TSN data.

With respect to the routing, the access nodes may employ the characteristics of the networking relationship as well. For example, if the networking relationship specifies that all data packets that are not addressed to any specific recipient shall be transmitted to the master device, the access node may employ this rule in the packet routing in the user context. Accordingly, upon receiving a packet over the bearer service that indicates no recipient, the access node may forward the packet towards the master device of the associated networking group.

Referring to FIG. 10, let us consider a specific example where the access node and the network controller employ the information on the networking relationship 550. Let us assume a case where the networking relationship is the TSN which specifies strict requirements to transmission timings of data packets within the networking group. Let us further assume that the master device (or another device) has been joined to employ the user context and has its bearer configuration completed (block 1000) in the above-described manner, for example. In connection with establishment of the bearer configuration or afterwards through signaling or by other means, timing information on the networking relationship 550 is received at the access node and/or the network controller (step 1002). The timing information may be received from the master device or be provided initially to the network controller before step 500, and it may comprise a clock of the networking relationship, for example. The access node and the network controller may share the timing information as it becomes available to either node and, as a consequence, all the entities involved in serving the networking group may be synchronized to the clock of the networking group. Thereafter, when a new device (the slave device in FIG. 10) requests is joined to the user context and its bearer(s) is/are configured in block 1004, the new device may be provided by the access node and/or the network controller with the timing information. Accordingly, the slave device becomes aware of the clock or other timing information, is capable of synchronizing to the networking group even without detecting any other device of the networking group, and may readily start transmitting packets by employing the timing information (step 1006). The transmission according to the timing information may be carried out within the networking relationship, e.g. within the ad hoc network, or over a bearer service of the user context.

The access node and the network controller may also employ the timing information in communication with the devices of the networking group such that the transmissions from the access node are synchronized to the clock of the networking group.

FIG. 11 illustrates an embodiment where admission of a new device to the user context triggers paging of one or more other devices of the networking group. Referring to FIG. 11, in connection with the bearer configuration in block 1000 or admission control preceding block 1000, the access node or the network controller may check the parameters of the user context and detect from the user context that the admission of the new device (device #2 in FIG. 11) triggers paging of specified one or more other devices. Accordingly, the access node may cause the paging in step 1100 which causes the one or more other devices to transmit a connection request (step 1102) to join the user context and have corresponding bearer service(s) configured (block 1104). In some industrial scenarios, multiple sensors may be operationally grouped such that activation of a single sensor causes activation of other sensors. Accordingly, attaching one sensor device to the user context may trigger attachment of the other sensors as well. The embodiment of FIG. 11 addresses this scenario and other, similar scenarios.

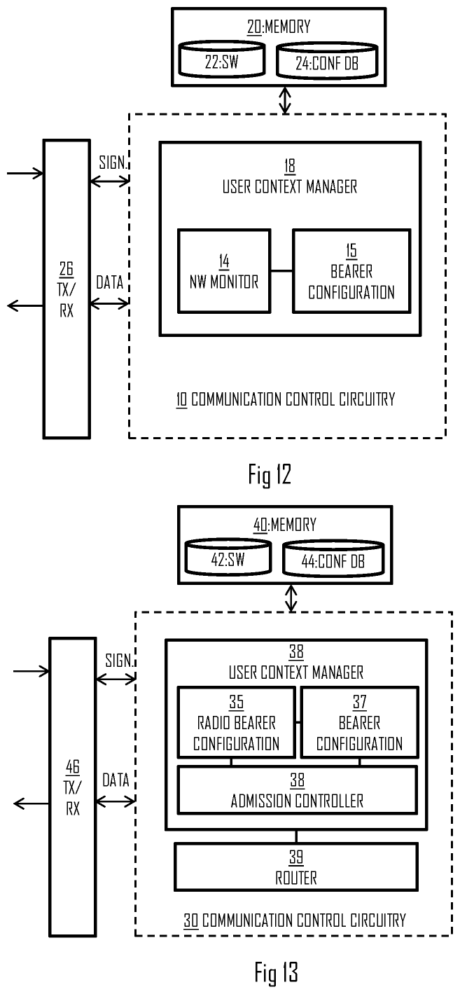

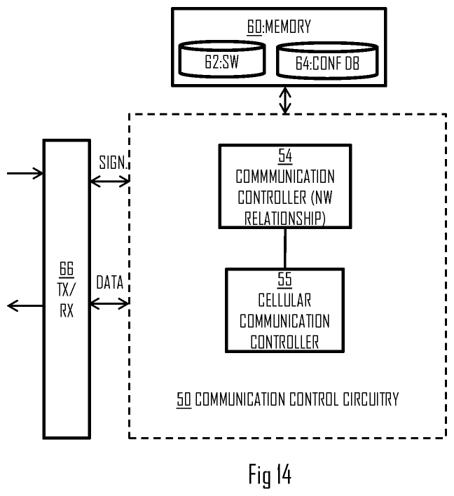

FIGS. 12 to 14 illustrate block diagrams of apparatuses according to some embodiments of the invention. FIG. 12 illustrates an apparatus for the network controller, FIG. 13 illustrates an apparatus for the access node, and FIG. 14 illustrates an apparatus for the device of the networking group. The apparatus of FIG. 14 may be a terminal device, a sensor device, a MTC device, or a user device, or the apparatus may be comprised in any one of such devices. The apparatus may be, for example, a circuitry or a chipset in such a device. The apparatus of FIG. 13 may be the access node or the network node 110, 112 described above, or the apparatus may be comprised in any one of such apparatuses. The apparatus may be, for example, a circuitry or a chipset in such an apparatus 110, 112. The apparatus of FIG. 12 may be an apparatus for a core network of a cellular communication system, or a server computer, or the apparatus may be comprised in any one of such apparatuses. The apparatus may be, for example, a circuitry or a chipset in such an apparatus. The apparatuses of FIGS. 12 to 14 may be electronic devices comprising electronic circuitries.

Referring to FIG. 12, the apparatus may comprise a communication control circuitry 10 such as at least one processor, and at least one memory 20 including a computer program code (software) 22 wherein the at least one memory and the computer program code (software) are configured, with the at least one processor, to cause the apparatus to carry out any one of the embodiments of the network controller described above.

The memory 20 may be implemented using any suitable data storage technology, such as semiconductor based memory devices, flash memory, magnetic memory devices and systems, optical memory devices and systems, fixed memory and removable memory. The memory may comprise a configuration database 24 for storing configuration data for use in serving devices of one or more networking groups. For example, the configuration database 24 may store information on the user contexts associated with the one or more networking groups, parameters of associated bearer services, etc.

The apparatus may further comprise a communication interface (TX/RX) 26 comprising hardware and/or software for realizing communication connectivity according to one or more communication protocols. The communication interface 26 may provide the apparatus with communication capabilities to communicate in a cellular communication system and/or in another network. The communication interface 26 may provide the apparatus with communication capability with the access nodes 110, 112 and with devices of the networking group. In an embodiment, the communication interface 26 provides the apparatus with internet protocol connectivity.

The communication control circuitry 10 may comprise a user context manager 18 configured to manage user contexts of the one or more networking groups. The user context manager may receive, through the communication interface or a user interface (not illustrated) an indication to establish a new user context for a networking group and, as a consequence, initiate the procedure of FIG. 5. The user context manager may comprise a bearer configuration circuitry 15 configured to execute blocks 504, 1000, and 1004 and associated steps 514, 516, 526. The bearer configuration circuitry may also carry out admission control and/or other tasks allocated to the network controller with respect to the configuration of the user context. The user context manager 18 may further comprise a networking relationship monitor 14 configured to monitor the characteristics of the networking group within the networking relationship. The monitor 14 may carry out steps block 900 or step 1002, for example, and then control the bearer configuration circuitry to reconfigure the bearer(s) of the networking group according to the monitored characteristics.

Referring to FIG. 13, the apparatus may comprise a communication control circuitry 30 such as at least one processor, and at least one memory 40 including a computer program code (software) 42 wherein the at least one memory and the computer program code (software) are configured, with the at least one processor, to cause the apparatus to carry out any one of the embodiments of the access node 110, 112 described above.

The memory 40 may be implemented using any suitable data storage technology, such as semiconductor based memory devices, flash memory, magnetic memory devices and systems, optical memory devices and systems, fixed memory and removable memory. The memory may comprise a configuration database 44 for storing configuration data for use in communication with other devices. For example, the configuration database 64 may store information on the established bearer services and associated parameters.

The apparatus may further comprise a communication interface (TX/RX) 46 comprising hardware and/or software for realizing communication connectivity according to one or more communication protocols. The communication interface 46 may provide the apparatus with communication capabilities to communicate in the cellular communication system and/or in another wireless network. The communication interface 66 may comprise standard well-known components such as an amplifier, filter, frequency-converter, (de)modulator, and encoder/decoder circuitries and one or more antennas. The communication interface 46 may comprise radio interface components providing the apparatus with radio communication capability in one or more wireless networks, e.g. with the devices of the networking group. The communication interface may further provide the apparatus with communication capability with one or more other access nodes and with the network controller, as described above.

The communication control circuitry may comprise a user context manager circuitry 38 configured to operate the user contexts as configured by the network controller. For example, upon receiving the indication to activate the user context in step 500 through the communication interface 46, the user context manager may trigger a bearer configuration circuitry 37 to establish a bearer service for the user context (block 504, 1000). The user context manager 38 may include an admission controller 38 configured to process connection requests received from devices of networking groups, to determine whether or not the user context has tasked the handling of the connection request to the admission controller 38 and process the request according to the result of the determination, as described above in 512, 522. Upon determining that the requesting device is admitted to the user context, the admission controller 38 may configure a radio bearer configuration circuitry 35 to establish a radio bearer for the device. The circuitries 35 and 37 may adapt the parameters of the respective bearers according to the changes in the characteristics of the networking group, as described above. The communication control circuitry 30 may further comprise a router circuitry 39 configured to perform data routing and/or address manipulation of received packets of the established user context(s) according to any one of the above-described embodiments.

Referring to FIG. 14, the apparatus may comprise a communication control circuitry 50 such as at least one processor, and at least one memory 60 including a computer program code (software) 62 wherein the at least one memory and the computer program code (software) are configured, with the at least one processor, to cause the apparatus to carry out any one of the embodiments of the device of a networking group described above. The device may be a master device or a slave device of the networking relationship.

The memory 60 may be implemented using any suitable data storage technology, such as semiconductor based memory devices, flash memory, magnetic memory devices and systems, optical memory devices and systems, fixed memory and removable memory. The memory may comprise a configuration database 64 for storing configuration data for use in communication with other devices. For example, the configuration database 64 may store configuration parameters of the above-described networking relationship within the networking group and, additionally parameters of established bearer services.

The apparatus may further comprise a communication interface (TX/RX) 66 comprising hardware and/or software for realizing communication connectivity according to one or more communication protocols. The communication interface 46 may provide the apparatus with radio communication capabilities to communicate in the cellular communication system and in at least one wireless network defining the networking relationship. The at least one other wireless network may employ a physical layer according to one communication protocol such as IEEE 802.15-based protocol and, additionally, an application layer protocols such as the HART or the TSN. The communication interface 66 may comprise standard well-known components such as an amplifier, filter, frequency-converter, (de)modulator, and encoder/decoder circuitries and one or more antennas. The communication interface 66 may comprise radio interface components providing the apparatus with radio communication capability in one or more wireless networks, e.g. with the devices of the networking group and with the access nodes of the cellular communication system.

The communication control circuitry 50 may comprise a cellular communication controller 55 configured to operate one or more bearer services of the user context associated with the networking group of the apparatus. The communication control circuitry 50 may further comprise a communication controller 54 controlling communication according to the specifications of the networking relationship. The controllers 54, 55 may operate cooperatively, and each controller 54, 55 may employ at least some parameters employed by the other controller or received from the other controller. For example, the cellular communication controller 55 may employ an address of the networking relationship in the communication according to the user context of the cellular access. As another example, the communication controller 54 may employ the timing information of the networking relationship as received by the cellular communication controller 55 from a serving access node. Accordingly, the communication controller 54 may acquire clock synchronization information for the networking relationship from the cellular communication controller 55.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

The techniques and methods described herein may be implemented by various means. For example, these techniques may be implemented in hardware (one or more devices), firmware (one or more devices), software (one or more modules), or combinations thereof. For a hardware implementation, the apparatus(es) of embodiments may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. For firmware or software, the implementation can be carried out through modules of at least one chipset (e.g. procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

Embodiments as described may also be carried out in the form of a computer process defined by a computer program or portions thereof. Embodiments of the methods described in connection with FIGS. 2 to 11 may be carried out by executing at least one portion of a computer program comprising corresponding instructions. The computer program may be in source code form, object code form, or in some intermediate form, and it may be stored in some sort of carrier, which may be any entity or device capable of carrying the program. For example, the computer program may be stored on a computer program distribution medium readable by a computer or a processor. The computer program medium may be, for example but not limited to, a record medium, computer memory, read-only memory, electrical carrier signal, telecommunications signal, and software distribution package, for example. The computer program medium may be a non-transitory medium. Coding of software for carrying out the embodiments as shown and described is well within the scope of a person of ordinary skill in the art.

Even though the invention has been described above with reference to an example according to the accompanying drawings, it is clear that the invention is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1.-53. (canceled)

54. An apparatus comprising:
at least one processor, and
at least one memory comprising a computer program code, wherein the processor, the memory, and the computer program code are configured to cause the apparatus to:
receive, from a network controller, a user context of a networking group, wherein the networking group comprises at least two devices;
receive a connection request from a device belonging to the networking group, wherein the device is in a networking relationship with at least one other user device of the networking group;
determine, on the basis of the received user context, whether or not the connection request shall be handled and responded by the apparatus; and
if the connection request shall be handled by the apparatus, handle the connection request and generate a response to the device and, otherwise, forward the connection request to the network controller.

55. The apparatus of claim 54, wherein the processor, the memory, and the computer program code are configured to cause the apparatus to receive the user context during setup of the networking group initiated by the network controller.

56. The apparatus of claim 54, wherein the user context of the networking group includes at least one of the following user context parameters: an identifier of the networking group, a maximum number of devices of the networking group, security information for the apparatus to carry out at least one of authentication and authorization and admission control, an identifier of at least one master device of the networking group, an identifier of a neighboring access node involved in serving the networking group and routing information for the networking group, a quality of service classification of the user context, and an indicator of a networking application protocol of the networking group.

57. The apparatus of claim 54, wherein the processor, the memory, and the computer program code are configured to cause the apparatus to perform said determining as based on at least one of the following criteria: a quality of service classification for traffic in the networking relationship, whether or not the device belongs to a particular device category within the networking group, whether or not the device requests for a particular service, and whether or not the device has a subscriber identity module of a cellular communication system of the apparatus.

58. The apparatus of claim 54, wherein the networking group comprises at least one device with a subscriber identity module of a cellular communication system and at least one device with no subscriber identity module of a cellular communication system.

59. The apparatus of claim 58, wherein the processor, the memory, and the computer program code are configured to cause the apparatus to identify the at least one device with no subscriber identity module by a combination of an identifier of the at least one device with the subscriber identity module and an identifier of the networking relationship.

60. The apparatus of claim 54, wherein the processor, the memory, and the computer program code are configured to cause the apparatus to perform, upon determining that the connection request shall be handled by the apparatus, admission control for the device and inform the network controller of the newly admitted device.

61. The apparatus of claim 54, wherein the networking relationship is defined by a communication protocol other than a communication protocol used for communication between the access node and the networking group.

62. The apparatus of claim 54, wherein the processor, the memory, and the computer program code are configured to cause the apparatus to handle the connection request by at least performing at least one of authentication of the device, authorization of the device, and admission control of the device.

63. The apparatus of claim 54, wherein the processor, the memory, and the computer program code are configured to cause the apparatus to perform said handling the connection request by at least paging for at least one other device of the networking group.

64. The apparatus of claim 54, wherein the processor, the memory, and the computer program code are configured to cause the apparatus to broadcast, upon receiving the user context, a message indicating availability of the user context.

65. The apparatus of claim 54, wherein the processor, the memory, and the computer program code are configured to cause the apparatus to acquire timing information associated with transmission timings within the networking group and, upon admitting a new device of the networking group to the user context, provide the new device with the timing information.

66. The apparatus of claim 54, wherein the user context comprises an identifier of at least one master device of the networking group, and wherein the processor, the memory, and the computer program code are configured to cause the apparatus to page for the master device upon receiving the user context.

67. The apparatus of claim 54, wherein the networking group comprises devices being in the networking relationship over a non-cellular communication protocol, and communication between the access node and the device is carried out over a cellular communication protocol.

68. An apparatus comprising:
at least one processor, and
at least one memory comprising a computer program code, wherein the processor, the memory, and the computer program code are configured to cause the apparatus to:
provide a networking relationship with at least one other apparatus, wherein said apparatus and said at least one other apparatus form a networking group;
cause transmission of a connection request to an access node external to the networking relationship, wherein the connection request comprises a request to join a user context of the networking group at the access node;
receive a response indicating admission of the apparatus to the user context shared by the apparatus and the at least one other apparatus of the networking group.

69. The apparatus of claim 68, wherein the processor, the memory, and the computer program code are configured to cause the apparatus to:
detect availability of the user context at the access node; and
cause said transmission of the connection request in response to said detecting.

70. The apparatus of claim 69, wherein the processor, the memory, and the computer program code are configured to cause the apparatus to detect the availability of the user context based on reception of a signal from the access node, the signal comprising information indicating the availability of the user context at the access node.

71. The apparatus of claim 68, wherein the processor, the memory, and the computer program code are configured to cause the apparatus to:
receive, in connection with the response indicating admission of the apparatus to the user context, timing information on the networking relationship; and
use the timing information when transmitting a message within the networking relationship or over a bearer service of the user context.

72. The apparatus of claim 68, wherein the networking group comprises devices being in the networking relationship over a non-cellular communication protocol, and communication between the apparatus and the access node is carried out over a cellular communication protocol.

73. A method comprising:
providing, in a device, a networking relationship with at least one other device, wherein said device and said at least one other device form a networking group;
causing, by the device, transmission of a connection request to an access node external to the networking relationship, wherein the connection request comprises a request to join a user context of the networking group at the access node;
receiving, by the device, a response indicating admission of the device to the user context shared by the device and the at least one other device of the networking group.
